(19) United States
(12) Patent Application Publication
(10) Pub. No.: US 2020/0275665 A1
(43) Pub. Date: Sep. 3, 2020

(54) PREPARATION COMPRISING AT LEAST ONE CHEMICAL FUNGICIDE AND A MIXTURE COMPRISING AUREOBASIDIUM PULLULANS STRAINS

(71) Applicant: Erber Aktiengesellschaft, Getzersdorf bei Traismauer (AT)

(72) Inventors: Eva-Maria BINDER, Tulln (AT); Christina Maria DONAT, Königsbrunn am Wagram (AR)

(73) Assignee: Erber Aktiengesellschaft, Getzersdorf bei Traismauer (AT)

(21) Appl. No.: 16/493,867

(22) PCT Filed: Mar. 7, 2018
(86) PCT No.: PCT/AT2018/000012

§ 371 Date: Sep. 13, 2019

(30) Foreign Application Priority Data
Mar. 15, 2017 (AT) A 104/2017

(51) Int. Cl. A01N 63/30; A01N 43/36; A01N 43/54

(52) U.S. Cl. CPC A01N 63/30; A01N 43/54; A01N 43/36

(57) ABSTRACT

The invention relates to a preparation comprising at least one chemical fungicide. In addition to the at least one chemical fungicide, a mixture is included which comprises at least the strains of Aureobasidium pullulans DMS 14940 and DSM 14941. The at least one chemical fungicide and the mixture of the strains Aureobasidium pullulans are present in the preparation in synergistically active quantities, and the at least one chemical fungicide is selected from fludioxinil or a combination containing fludioxinil and at least one second chemical fungicide. The invention also relates to the use of the preparation and to a method for the prophylaxis or the reduction of the spread of at least one plant disease caused by a fungal pathogen.

The present invention relates to a preparation comprising at least one chemical fungicide and to the use of the preparation, and methods for the prophylaxis or the reduction of the spread of at least one plant disease caused by a fungal pathogen.

So as to be able to maximize crop yields in agriculture to the greatest extent possible, it is necessary to protect agricultural products from infestation by pests in the best possible manner. This is of great importance in all agricultural cultures, and in the cultivation of fruits and vegetables in particular, and to protect the crop plants from infection by pathogens, it is customary to spray or treat these with chemical fungicides so as to prevent plant pathogen infection or reduce the spread thereof. Such chemical fungicides usually have a very broad application spectrum and do not act specifically against individual pathogens, so that they are widely used. Similarly to what is known from antibiotics, over time the pathogens develop resistance or reduced sensitivity to such fungicidally acting chemical substances, and the effect of the chemical fungicides used for the treatment or prevention of infection by pathogens gradually decreases, until the pathogenic substances have become so resistant to the sprayed agents that it is necessary to search for a new substance.

In addition to the problem that, over time, pathogens develop resistance or reduced sensitivity to chemical fungicides, the chemical fungicides also have the problem that these at least partially make their way into the soil after having been applied to the plants to be treated, which can result in contamination and, in addition to the contamination, it is also possible for additional microorganisms whose treatment or prevention was not even intended in the present case to become resistant to these chemical fungicides. In this way, the undesirable effect occurs that not only the target organisms (pathogens) can become resistant, but also non-target organisms, whose treatment was not originally intended by the use of the particular chemical fungicide. The consequence of this can be that these non-target organisms, in turn, form resistance or reduced sensitivity completely undetected and then, when it matters, cannot be treated with conventional chemical fungicides or a treatment will not deliver the desired success.

Plants, fruits or vegetables thus treated subsequently enter the food cycle of livestock and people and, as a result of the unknown contamination with fungicides, can cause great damage, for example in that secondary resistance is developed.

Moreover, public opinion is growing increasingly negative toward the use of chemical fungicides since people, based on their ever greater knowledge regarding the mechanism of action and consequences of the excessive use of chemical fungicides, reject and want to roll back the use thereof to the greatest extent possible, which necessitates the search for alternatives.

In addition to the use of chemical fungicides, it has been known for quite some time to employ biological fungicides, which have the advantage that the pathogens cannot develop resistance to these biological fungicides. Whether and to what extent the activity of biological agents can be equated to that of chemical fungicides depends on the specific biological agent used, or the biological mixture, and on the specific pathogen against which an effect is to be achieved, so that a multitude of tests and analyses is necessary for each individual case.

Fungicidal compositions for combating phytopathogenic diseases on useful plants became known from DE 699 19 762 T2, in which a combination of two fungicidally acting substances was employed so as to achieve a synergistic fungicidal effect, and thereby be able to lower the overall amount of fungicidal substances used.

Furthermore, a mixture can be derived from EP 0 930 824 B1 which is essentially composed of a preparation of the plant Reynoutria sachalinensis and a nitrogen fertilizer, the mixture being usable to prevent the infection by fungal plant pathogens and to combat fungal plant pathogens. This mixture is also intended to reduce the overall quantity of applied active substances.

Finally, a protective and curative composition and corresponding compositions for the biocontrol of plant diseases can be derived from WO 99/62341, wherein the compositions are intended, in particular, for post-harvest use. Such a composition comprises at least one antagonistic microorganism and an, in particular biological, antifungal agent, such as an enzyme.

Finally, R. Castoria et al. (Postharvest Biology and Technology 22, pages 7 to 17, 2001) described the activity of Aureobasidium pullulans (LS-30) as an antagonist of pathogenic substances on fruits infecting these post-harvest, in which it was established that Aureobasidium pullulans exhibits significant antagonistic effectiveness against Botrytis cinerea, Penicillium expansum, Rhizopus stolonifer and Aspergillus niger in various plants. Among other things, apple wounds were treated with Aureobasidium pullulans (LS-30) and, for comparison, wounds were only treated with water. These results demonstrated that Aureobasidium pullulans exhibits good antagonistic effectiveness against fungal apple decay pathogens.

WO 2008/114304 describes the use of Aureobasidium pullulans strains in conjunction with the adjuvants calcium propionate and calcium propionate with soybean oil or with the fungicide procymidone for combating Botrytis cinerea on wine grapes. However, neither a combination of individual Aureobasidium pullulans strains nor of an Aureobasidium pullulans strain with the fungicide fludioxonil or a mixture of cyprodinil and fludioxonil was tested.

Finally, a combination of cyprodinil and Aureobasidium pullulans DSM 14940 and DSM 14941 was already suggested on the homepage of BIOFA company [http://www.biofa-profi.de/de/b/blossomprotecttm.html?file=files/content/Prdukte/Blossom ProtectTM/bloss omprotect produkthandbuch 2012.pd]. The miscibility list likewise included in this document, however, reveals a plurality of chemical fungicides that, due to the non-miscibility thereof with the product Blossom Protect™ or Boni Protect™ containing Aureobasidium pullulans DSM 14940 and DSM 14941, cannot be used in the preparations described in this document.

Despite these findings, a continued need exists to provide additional effective fungicides or fungicidal mixtures, which allow the usage amount of chemical fungicides to be considerably reduced, and by which additionally a considerably enhanced effect can be achieved compared to the use of an individual substance, and more specifically of both at least one chemical fungicide and a biological active substance.

To achieve this object, the preparation according to the present invention is essentially characterized in that, in addition to the at least one chemical fungicide, a mixture comprising at least the Aureobasidium pullulans strains DSM 14940 and DSM 14941 is present, wherein the at least one chemical fungicide and the mixture of the Aureobasidium pullulans strains are present in the preparation in synergistically acting amounts, and that the at least one chemical fungicide is selected from fludioxonil or a combination comprising fludioxonil and cyprodinil. By the preparation comprising a mixture including at least the Aureobasidium pullulans strains DSM 14940 and DSM 14941 in synergistically effective amounts, in addition to the at least one chemical fungicide, it is possible to achieve a better fungicidal effect than if the individual substances were used alone or separately. Finally, such a procedure makes it possible to eliminate or prevent resistance to the chemical fungicides composed of fludioxonil, or a combination comprising fludioxonil and cyprodinil, which is already being observed when these are used alone, and thereby considerably enhance the effectiveness of the fungicides again in a surprising manner. The composition is particularly effective in the prophylaxis of fungal pathogens that exhibit at least resistance or lower sensitivity to at least one of the chemical fungicides in the preparation. Particularly effective means that the synergism factor of the preparation compared to the individual substances is greater than 1.1.

In particular, a combination of fludioxonil and cyprodinil is preferred. In particular, cyprodinil or fludioxonil at preset already exhibit considerably limited effectiveness against fungal pathogens since these are already developing resistance to these two active substances. Surprisingly, it was possible to demonstrate that, when a combination of the chemical fungicides fludioxonil and cyprodinil is present in a preparation according to the invention, the resistance can be suppressed, and the substances are able to develop the full effect thereof against fungal pathogens, even if they are present in the preparation in lower concentrations.

The term “preparation” shall be understood to mean a ready-to-use solution or suspension that comprises all the individual substances, namely at least one chemical fungicide and the two Aureobasidium pullulans strains DSM 14940 and DSM 14941, and that is applied directly to plants. Typically, preparations are aqueous solutions or suspensions, also referred to as tank mixes, which are usually mixed prior to being applied to the plants. The individual substances or components are mixed in concentrated liquid or solid form with water in a tank and dissolved or suspended. It is immaterial whether the individual substances or components are introduced into the tank separately, or in the form of a concentrated premix comprising at least one chemical fungicide and the two Aureobasidium pullulans strains DSM 14940 and DSM 14941, mixed with water and dissolved or suspended. The order in which water and the individual substances or components or the premix are introduced into the tank is immaterial. The individual substances or components or the concentrated premixes are diluted in the tank by a factor of 1:10, 1:100, 1:1000 or 1:10000, for example, to achieve the effective concentration in the composition. Surprisingly, the present preparations have now been successfully used to produce a mixture of fludioxonil or of fludioxonil and cyprodinil and the two Aureobasidium pullulans strains DSM 14940 and DSM 14941, even though known products comprising these strains or these chemical fungicides were described in the literature as not being miscible [http://www.biofa-profi.de/de/b/blossomprotecttm.html?file=files/content/Prdukte/BlossomProtectTM/bloss omprotect produkthandbuch 2012.pd]).

The term “chemical fungicide” shall be understood to mean a chemical, fungicidal active substance, in particular cyprodinil (CAS No. 121552-61-2), fludioxonil (CAS No. 131341-86-1), wherein the presence of at least fludioxonil as at least one chemical fungicide in the preparation is mandatory.

The term “fungal pathogen” here shall be understood to mean a microorganism that causes a disease in the host thereof. Fungal pathogens are preferably the microorganisms Neofabreaea spp., in particular Pezicula malicorticis (DSMZ 62715), and Botrytis spp., in particular Botrytis cinerea, which cause diseases in fruit, wine and vegetable cultures, and in particular apples, wine grapes, strawberries and cucurbits, such as zucchini and squash.

A particularly good synergistic effect is achieved in that the at least one chemical fungicide and a mixture comprising at least the Aureobasidium pullulans strains DSM 14940 and DSM 14941 are present in the preparation in synergistically effective amounts. Surprisingly, it has been found that the use or the application of a chemical fungicide, comprising at least fludioxonil and the mixture comprising at least two different Aureobasidium pullulans strains, namely DSM 14940 and DSM 14941, exhibits a significantly enhanced, in particular synergistic, effectiveness compared to the use of only one of the two Aureobasidium pullulans strains and the chemical fungicide. The cell quantity ratio of the two Aureobasidium pullulans strains DSM 14940 and DSM 14941 with respect to one another is selected between 2:1 and 1:2, and in particular 1:1, so that a corresponding mixture is also easy to produce.

A particularly reliable, and in particular synergistic, effect of the preparation is achieved when the Aureobasidium pullulans strains DSM 14940 and DSM 14941 are each present in a concentration of 1×10⁵ to 1×10⁸ cells/ml preparation. By the presence of the Aureobasidium pullulans strains DSM 14940 and DSM 14941 in a respective concentration of 1×10⁵ to ×10⁸ cells/ml preparation, preferably 1×10⁶ to 2×10⁷ cells/ml preparation, preferably 1.67×10⁶ to 3.33×10⁶ cells/ml preparation, and particularly preferably of 2.5×10⁶ cells/ml preparation, the use of this preparation makes it possible to successfully suppress decay caused by various fungal pathogens selected from the group consisting of Neofabreaea spp., in particular Pezicula malicorticis (DSMZ 62715), and Botrytis spp., in particular Botrytis cinerea, Monilinia spp., Penicillium spp., Coletotrichum spp. and others, in a safe and reliable manner, and in particular to prevent rotten spots caused by external injuries of the fruits from growing.

According to a refinement of the invention, the preparation is designed in such a way that cyprodinil is present in a concentration of 0.00375 g/l preparation to 5 g/l preparation, preferably 0.02 g/l preparation to 1.0 g/l preparation, in particular 0.1875 g/l preparation to 0.375 g/l preparation, and that fludioxonil is present in a concentration of 0.0025 g/l preparation to 5 g/l preparation, preferably 0.01 g/l preparation to 1.0 g/l preparation, in particular 0.125 g/l preparation to 0.25 g/l preparation, as synergistically acting amounts. The amount of chemical fungicides used depends primarily on whether the fungal pathogen already exhibits resistance or reduced sensitivity to the at least one chemical fungicide. When the chemical fungicides cyprodinil or fludioxonil are present in the preparation in the indicated amounts, they are able to fully develop the effect thereof against fungal pathogens, despite being present in small amounts, and, surprisingly, the fungal pathogens do not exhibit any or reduced resistance or sensitivity to these known fungicides in combination with Aureobasidium pullulans strains DSM 14940 and DSM 14941. Moreover, the preparation according to the invention, which comprises the mixture of Aureobasidium pullulans strains DSM 14940 and DSM 14941, exhibited a synergistic effect, so that it is sufficient to use an amount that is considerably lower than the sum of the amounts of the respective individual substances or components which would have been necessary to an achieve equally good effect.

A synergistic effect, in the present case, shall be understood to mean an over-additive increase in the fungicidal activity of a combination of at least one chemical fungicide with a mixture of the two Aureobasidium pullulans strains DSM 14940 and DSM 14941 compared to a) the sole use of the at least one chemical fungicide or compared to b) the sole use of the mixture of the two A. pullulans strains DSM 14940 and DSM 14941 or compared to c) the use of the at least one chemical fungicide together with only one of the two A. pullulans strains DSM 14940 or DSM 14941. The use of the A. pullulans strains DSM 14940 and DSM 14941 individually in combination with chemical fungicides or the use of mixtures of conventional A. pullulans strains (AP 241 and AP 298) with one another, or with one of the two A. pullulans strains DSM 14940 and DSM 14941, in combination with chemical fungicides likewise surprisingly showed no synergistic effect. The procedure for mathematically calculating the synergistic effect follows that set out in Colby et al. (Weeds 15, pages 20 to 22, 1967), wherein a synergism factor of greater than 1 is considered to confirm the presence of a synergistic effect.

The best effect was able to be achieved by a preparation according to the invention being essentially characterized in that cyprodinil and fludioxonil are present in the preparation in a weight ratio of 2:1 to 1:2, preferably of 2:1 to 1:1, and in particular of 1.5:1. Using two chemical fungicides in the preparation, in addition to two biological fungicides (=A. pullulans strains DSM 14940 and DSM 14941), not only successfully achieves a broad spectrum effect against fungal pathogens, but surprisingly shows that the amounts of the individual substances were able to be drastically reduced, whereby a synergistic effect of all components is proven.

The invention is furthermore directed to the use of a preparation according to the present invention, which is used for prophylaxis and/or for curbing the spread of plant diseases caused by fungal pathogens.

With such use, it is possible to successfully curb or completely halt the development and/or spread of plant diseases in the affected fruits, whereby a longer storage time of the crop can be ensured and, in particular, the spread of fungal pathogens can be suppressed.

The preparation is particularly preferably applied in the case of plant diseases caused by the fungal pathogens selected from the group consisting of Neofabreaea spp, in particular Neofabraea malicoricis or Pezicula malicorticis, Botrytis spp., in particular Botrytis cinerea, Monilinia spp., Penicillium spp., Coletotrichum spp. The best results can be achieved for these fungal pathogens, in particular for N. malicortcis and B. cinerea, and, in particular, a spread of the plant disease can be almost completely suppressed in the affected plants, and additionally good prophylaxis against the occurrence of the plant diseases can be provided.

The highest synergistic effects are achieved when, as corresponds to a refinement of the invention, the preparation is designed in such a way that Aureobasidium pullulans DSM 14940 and DSM 14941 are each present in a cell quantity ratio of 1×10⁶ to 2×10⁷ cells/ml preparation, preferably 1.67×10⁶ to 3.33×10⁶ cells/ml preparation, particularly preferably of 2.5×10⁶ cells/ml preparation, and the chemical fungicides fludioxonil and cyprodinil are present in a concentration of preferably 0.0025 g/l preparation to 1.0 g/l preparation, in particular 0.125 g/l preparation to 0.25 g/l preparation for fludioxonil, and 0.00375 g/l preparation to 1.0 g/l preparation, in particular 0.1875 g/l preparation to 0.375 g/l preparation for cyprodinil. Such a preparation allows synergism factors of up to 1.5 to be achieved.

A particularly preferred use according to the invention is characterized in that the fungal pathogens, in particular Botrytis cinerea and Neofabraea malicoricis (Pezicula malicorticis), exhibit resistance and/or reduced sensitivity to at least one chemical fungicide, namely fludioxonil. When the fungal pathogens exhibit resistance or reduced sensitivity to the at least one chemical fungicide, the preparation according to the invention can be used, since the fungal pathogens are sensitive to the preparation used, and the pathogens are successfully rendered harmless. Surprisingly, in particular a chemical fungicide to which a pronounced resistance was exhibited was also able to be used. This is attributed to the fact that the pathogens have to expend energy to maintain resistance, which they are not able to expend as a result of the use of the Aureobasidium pullulans strains DSM 14940 and DSM 14941 and the antagonistic activity thereof as competitors for food, and the action of the at least one chemical fungicide can thus again take place without limitation.

Preferably, the at least one chemical fungicide and at least one mixture comprising the Aureobasidium pullulans strains DSM 14940 and DSM 14941 are used in synergistically effective amounts in the process. As a result of such use, the amount of fungicidal substances used, and more specifically of both biological and chemical substances, can be considerably reduced compared to the individual substances, without lowering the fungicidal effect. In this way, it is successfully achieved that the contamination of the environment by the harmful chemical fungicides, such as fludioxonil, is considerably reduced, and moreover that safe and reliable protection of fruits is achieved, in particular protection against fungal pathogens such as N. malicortcis, B. cinerea, Monilinia spp., Penicillium spp., and Coletotrichum spp.

The at least one chemical fungicide is selected from fludioxonil and at least one second chemical fungicide selected from the group consisting of cyprodinil, fenhexamid, fenpyrazamine and pyrimethanil or from a mixture of cyprodinil and fludioxonil in a weight ratio of 2:1 to 1:2, preferably of 2:1 to 1:1, and in particular of 1.5:1. By using the chemical fungicide in the form of a mixture of cyprodinil and fludioxonil in a weight ratio of 2:1 to 1:2, and in particular 1.5:1, a particularly broad protection against a multitude of fungal pathogens can be achieved.

The amount of chemical fungicides used can be reduced even further when the Aureobasidium pullulans strains DSM 14940 and DSM 14941 are used in a cell quantity ratio of 2:1 to 1:2, and preferably of 1:1. The cell quantity ratio refers, in particular, to the cell count used.

Finally, the invention relates to a method for the prophylaxis or the reduction of the spread of at least one plant disease caused by a fungal pathogen, which is essentially characterized by applying
a) at least one chemical fungicide selected from fludioxonil or a combination comprising fludioxonil and cyprodinil and
b) a mixture comprising at least the Aureobasidium pullulans strains DSM 14940 and DSM 14941
jointly at least once to a crop plant, wherein a) and b) are applied in synergistically effective amounts to the crop plant, in particular by spraying, misting or irrigation.

Such a method can be used to successfully render fungal pathogens, the habitat thereof or the fruit, wine and vegetable cultures to kept free therefrom, harmless, in particular apples, wine grapes, strawberries and cucurbits, such as zucchini and squash, by applying at least one chemical fungicide selected from fludioxonil or a combination comprising fludioxonil and cyprodinil and the two Aureobasidium pullulans strains DSM 14940 and DSM 14941. The method is preferably implemented in such a way that a preparation is applied by spraying, misting or irrigation. Despite using small amounts of the chemical fungicides and biological fungicides, such a method can be used to successfully apply an active substance preparation to the plants, fruits or vegetables to be treated, in particular apples, which safely and reliably kills the fungal pathogens, such as Neofabreaea spp., Botrytis spp., Monilinia spp., Penicillium spp., Coletotrichum spp., in particular N. malicortcis (Pezicula malicorticis) and B. cinerea, or curbs the spread thereof. For the synergistic effect to occur, it is important that components a) and b) are present on the crop plant jointly and concurrently. Theoretically, it is possible to apply components a) and b) separately from one another, or also to apply the two Aureobasidium pullulans strains DSM 14940 and DSM 14941 of component b) separately from one another, as long as these are present or act on the crop plant at the same time. It is possible to adjust a) and b) or the individual Aureobasidium pullulans strains DSM 14940 and DSM 14941 in separate tank mixes to the desired amount or concentration and to apply these in keeping with the desired application amount per hectare (ha) to the crop plants concurrently or in quick succession. However, for the sake of simplicity, and above all because in this case the joint presence of the components of the preparation can be ensured, as well as for cost reasons, it is preferred to apply components a) and b) jointly, that is, components a) and b) are present in the same tank mix or preparation.

The method is advantageously implemented in such a way that a) and b) are mixed, dissolved or suspended jointly in a preparation, and that the preparation is applied to the crop plant. Such an implementation of the method allows a ready-to-use solution, suspension or mixture to be produced directly, which can be directly applied to crop plants to be treated.

Particularly good results can be achieved when the method is implemented in such a way that, for each use, 1×10¹¹ to 1×10¹⁴ cells/ha, preferably 1×10¹² to 2×10¹³ cells/ha preparation, preferably 1.67×10¹² to 3.33×10¹² cells/ha preparation, and particularly preferably 2.5×10¹² cells/ha of the individual Aureobasidium pullulans strains DSM 14940 and DSM 14941 are applied. By applying such cell counts of the Aureobasidium pullulans strains DSM 14940 and DSM 14941, effective prophylaxis or a considerable reduction in the spread of plant diseases caused by fungal pathogens was able to be achieved. Similarly, effective prophylaxis or a considerable reduction in the spread of plant diseases caused by fungal pathogens was able to be achieved when, according to one refinement of the invention, the method is implemented in such a way that fludioxonil is used as the chemical fungicide, wherein in particular 2.5 g/ha to 5000 g/ha, preferably 10 g/ha to 1000 g/ha, and in particular 125 g/ha to 250 g/ha is applied, or a mixture of fludioxonil and cyprodinil is used, wherein in particular 3.75 g cyprodinil/ha to 5000 g cyprodinil/ha, preferably 20 g/ha to 1000 g/ha, and in particular 187.5 g/ha to 375 g/ha is applied.

It is particularly effective when the method is implemented in such a way that the at least one application of the at least one chemical fungicide and of the at least two Aureobasidium pullulans strains DSM 14940 and DSM 14941, and in particular of the above-defined preparation, is carried out during the flowering stage of the crop plant. By applying the preparation during the flowering stage of the crop plant, a particularly efficient prophylaxis or reduction in the spread of plant diseases caused by fungal pathogens is achieved. The internationally customary BBCH scale of the development stages is used for the definition of the flowering stage of the crop plant, wherein the flowering stage of grapevines herein corresponds to the BBCH scales 53, 55, 57 and 60-69 (Lorenz et al., Phänologische Entwicklungsstadien der Weinrebe (Phenological development stages of the grapevine). Vitic. Enol. Sci. 49, 66-70, 1994) and of strawberries herein corresponds to the BBCH scales 55-59, 60, 61, 65 and 67 (Meier et al., Phänologische Entwicklungsstadien des Kernobstes, des Steinobstes, der Johannisbeere and der Erdbeere (Phenological development stages of pomaceous fruits, stone fruits, currents and strawberries). Nachrichtenbl. Deut. Pflanzenschutz (German Plant Protection Bulletin), 46, 141-153, 1994). Multiple concurrent applications of components a) and b) during the flowering stage, or during the flowering stage and subsequent development stages, namely the development of the fruit and maturity of the fruit, can further increase the synergistic effect.

The invention will be described in more detail hereafter based on exemplary embodiments.

### EXAMPLE 1: AUREOBASIDIUM PULLULANS STRAINS AND CHEMICAL FUNGICIDES TO COMBAT FUNGAL PLANT PATHOGENS

The effect of the Aureobasidium pullulans strains AP 241 (DSM 32467), AP 268 (DSM 32468), DSM 14940 and DSM 14941 (individually or in combination), together with the chemical fungicides cyprodinil and fludioxonil (individually or in combination), against the fungal plant pathogens Botrytis and Neofabreaea was determined in an apple test. 12 untreated apples of the same cultivar, having a uniform degree of maturity and size, were used for each treatment. Prior to the test, the apples were surface-sterilized for three minutes in 70% ethanol and dried in a clean bench. Four wounds, having a wound diameter of 5 mm, were made at equal distances in each apple in the equatorial plane between the calyx and the stem using a sterile pipette tip. Immediately after the creation of the four artificial wounds, 10 μl of different test solutions (preparations) was applied to each apple. Thereafter, the apples were stored. An area of decay formed around the wounds, the diameter of the area representing a measure of the spread of the infection with the pathogen. For the evaluation, the diameters of the punctures of 0.5 cm each were deducted from the diameter of the decay area.

The 4 test solutions that were each placed in one of the 4 wounds of each apple were:
1. Pathogen (negative control)
2. Pathogen and Aureobasidium pullulans (individually or in combination)
3. Pathogen and chemical fungicide (individually or in combination)
4. Pathogen and Aureobasidium pullulans (individually or in combination) and chemical fungicide (individually or in combination)

The effectiveness of the inhibition of the pathogen was calculated for test solutions 2 to 4 from the diameters of the areas of decay, which were measured at the end of the storage period. This effectiveness corresponds to the decrease in the diameter of the decay area, in percent, compared to the respective negative control. If, for example, the diameter of the decay area of test solution 1 was 5 cm, and that of test solutions 2, 3 or 4 was 1 cm, respectively, the effectiveness of test solutions 2 to 4 would be 80%, respectively. The effectiveness of the negative control is zero by definition.

According to the Colby formula (S. R. Colby “Calculating synergistic and antagonistic responses of herbicide combinations,” Weeds 15, pages 20 to 22, 1967), expected values (E) of the effect of the combination of Aureobasidium and the chemical fungicide (test solution 4) were calculated from the effectiveness (WG) figures of the individual components in test solutions 2 and 3 according to the following formula:

E=WGX+(WGY/100)×(100−WGX)
E . . . expected value
WG X . . . effectiveness of individual component X
WG Y . . . effectiveness of individual component Y

If the measured effectiveness of the combination of the Aureobasidium pullulans strains and the chemical fungicide (test solution 4) is greater than the calculated expected value (E), this is referred to as a synergistic effect (the individual components potentiate each other in an over-additive effect). The synergism factor is a measure of the synergistic effect and was calculated as the quotient from the effectiveness of the combination of the substances or components (test solution 4) and the calculated expected value (E). If the synergism factor is greater than or equal to 1.1, the effect of the combination is synergistic compared to the effect of the individual components. When the present document refers to “synergism” or “synergistically acting” or “synergistic effect” or the like, this always relates to combinations having a synergism factor of greater than or equal to 1.1 compared to the individual components of the combination. For each experimental setup, consisting of test solutions 1 to 4, 12 replicas (12 apples) were examined.

Tested Fungal Plant Pathogens:
Botrytis spp.:
Botrytis cinerea Bc97 (DSM 32469)

This strain exhibits resistance to the chemical fungicides strobilurin, boscalid and cyprodinil as well as reduced sensitivity to fludioxonil.
Botrytis cinerea 12/4 (DSM 32486)

This strain does not exhibit any known reduced sensitivity or resistance to chemical fungicides.
Neofabreaea spp.: Pezicula malicorticis 160622 (DSM 62715)

Pathogen Solutions:

To produce the pathogen solutions, conidia were removed from ME nutrient agar plates (ME agar: 30 g malt extract, 15 g agar, 5 g peptone on 1000 ml distilled water), on which pathogens were grown at 20° C., over a surface area of approximately 1-2 cm by 2 cm, and then suspended in 10 ml water in a Dounce homogenizer. Thereafter, the conidia concentration was microscopically counted in the Thoma chamber and set to the desired concentration using water.
Botrytis
Final concentration of the conidia in the test solution: 2×10⁵ conidia/ml
Concentration of the conidia in the 2× concentrated pathogen solution: 4×10⁵ conidia/ml
Neofabreaea
Final concentration of the conidia in the test solution: 1×10⁶ conidia/ml
Concentration of the conidia in the 2× concentrated pathogen solution: 2×10⁶ conidia/ml

Aureobasidium pullulans Strains:
DSM 14940
DSM 14941
AP 241 (DSM 32467) isolated Aureobasidium pullulans strain
AP 268 (DSM 32468) isolated Aureobasidium pullulans strain

Aureobasidium pullulans Concentrations:

The Aureobasidium pullulans strains DSM 14940, DSM 14941, AP 241 and AP 268 were cultivated on nutrient agar plates (YM Agar: 3 g yeast extract, 3 g malt extract, 5 g peptone, 10 g glucose and 20 g agar on 1000 ml distilled water) at 27° C., and the cells were harvested with 0.6% NaCl solution. The concentration of the yeast cells was microscopically counted in the Thoma cell counting chamber and set to the desired concentration using water. Examinations of the cell viability and of the colony forming units showed that >99.9% of the cells are viable and able to form colonies. The information regarding the cells, and in particular the cells/ml, provided herein thus also synonymously denotes colony forming units (CFU), and in particular CFU/ml.
2× concentrated Aureobasidium solution: 1×10⁷ cells/ml
4× concentrated Aureobasidium solution: 2×10⁷ cells/ml

Final Concentration in the Test Solution (Preparation):
DSM 14940, DSM 14941, AP 241 and AP 268: 5×10⁶ cells/ml
AP 1: 1:1 mixture of DSM 14940 and DSM 14941: 2.5×10⁶ cells/ml DSM 14940 and 2.5×10⁶ cells/ml DSM 14941
AP 2:1:1 mixture of DSM 14940 and AP 241: 2.5×10⁶ cells/ml DSM 14940 and 2.5×10⁶ cells/ml AP 241
AP 3:1:1 mixture of DSM 14940 and AP 268: 2.5×10⁶ cells/ml DSM 14940 and 2.5×10⁶ cells/ml AP 268
AP 4:1:1 mixture of DSM 14941 and AP 241: 2.5×10⁶ cells/ml DSM 14941 and 2.5×10⁶ cells/ml AP 241
AP 5:1:1 mixture of DSM 14941 and AP 268: 2.5×10⁶ cells/ml DSM 14941 and 2.5×10⁶ cells/ml AP 268
AP 6: 2:1 mixture of DSM 14940 and DSM 14941 (3.33×10⁶ cells/ml DSM 14940 and 1.67×10⁶ cells/ml DSM 14941)
AP 7:1:2 mixture of DSM 14940 and DSM 14941 (1.67×10⁶ cells/ml DSM 14940 and 3.33×10⁶ cells/ml DSM 14941)

Chemical Fungicides:

The following chemical fungicides, having the concentrations indicated in the table, were used:

| | Concentration of the active | | |
|---|---|---|---|
| | substance of the chemical | | 4x concentrated |
| | fungicide in the test solution or | 2x concentrated chemical | chemical fungicide |
| # | preparation | fungicide solution | solution |
| A | 0.01875% (w/v) cyprodinil | 0.0375% (w/v) cyprodinil | 0.075% (w/v) |
| | (=0.1875 g/l preparation) | 0.0250% (w/v) fludioxonil | cyprodinil |
| | 0.01250% (w/v) fludioxonil | | 0.050% (w/v) |
| | (=0.125 g/l preparation) | | fludioxonil |
| B | 0.01250% (w/v) fludioxonil | 0.0250% (w/v) fludioxonil | 0.050% (w/v) |
| | (=0.125 g/l preparation) | | fludioxonil |
| C | 0.01875% (w/v) cyprodinil | 0.0375% (w/v) cyprodinil | 0.075% (w/v) |
| | (=0.1875 g/l preparation) | | cyprodinil |

Test Solutions Per Wound:

| Wound/ | | |
|---|---|---|
| test | | Composition of the test solution |
| solution | Batch | applied to the apple wound |
| 1 | Pathogen control | 5 μl 2x concentrated pathogen solution |
| | | 5 μl water |
| 2 | Pathogen + Aureobasidium | 5 μl 2x concentrated pathogen solution |
| | | 5 μl 2x concentrated Aureobasidium solution |
| 3 | Pathogen + | 5 μl 2x concentrated pathogen solution |
| | chemical fungicide | 5 μl 2x concentrated chemical fungicide |
| | | solution |
| 4 | Pathogen + Aureobasidium + | 5 μl 2x concentrated pathogen solution |
| | chemical fungicide | 2.5 μl 4x concentrated Aureobasidium |
| | | solution |
| | | 2.5 μl 4x concentrated chemical fungicide |
| | | solution |

Results

Botrytis cinerea Bc97

Test system: apples of the Jonagold Honsel cultivar

Storage temperature: 20° C.; storage period: 6 days

Pathogen: Botrytis cinerea Bc97

Aureobasidium pullulans strains: DSM 14940, DSM 14941, AP 241, AP 268

Chemical fungicides: fludioxonil, cyprodinil

| | | Aureobasidium strain | | | |
|---|---|---|---|---|---|
| | | DSM 14940 | DSM 14941 | AP 241 | AP 268 |
| | Chemical fungicide (w/v) | 0.125 g/l fludioxonil | | | |
| Mean diameter | Pathogen control | 3.18 | 3.44 | 3.03 | 2.62 |
| of decay areas | Pathogen + Aureobasidium | 3.03 | 2.65 | 2.80 | 2.45 |
| (cm) | Pathogen + chemical fungicide | 0.68 | 0.28 | 0.48 | 0.53 |
| | Pathogen + Aureobasidium + | 0.78 | 0.40 | 0.42 | 0.45 |
| | chemical fungicide | | | | |
| Effectiveness | Pathogen control | 0.0 | 0.0 | 0.0 | 0.0 |
| | Pathogen + Aureobasidium | 4.7 | 23.0 | 7.7 | 6.4 |
| | Pathogen + chemical fungicide | 78.8 | 91.8 | 84.3 | 79.9 |
| | Pathogen + Aureobasidium + | 75.7 | 88.4 | 86.3 | 82.8 |
| | chemical fungicide | | | | |
| Expected value | Pathogen + Aureobasidium + | 79.8 | 93.7 | 85.5 | 81.2 |
| (E) | chemical fungicide | | | | |
| Synergism factor | | 1.0 | 0.9 | 1.0 | 1.0 |

| | | Aureobasidium strain | | | |
|---|---|---|---|---|---|
| | | DSM 14940 | DSM 14941 | AP 241 | AP 268 |
| | Chemical fungicide (w/v) | 0.1875 g/l cyprodinil | | | |
| Mean diameter | Pathogen control | 3.41 | 3.56 | 2.95 | 3.13 |
| of decay areas | Pathogen + Aureobasidium | 3.30 | 3.45 | 2.88 | 2.96 |
| (cm) | Pathogen + chemical fungicide | 2.80 | 3.14 | 2.21 | 2.52 |
| | Pathogen + Aureobasidium + | 2.73 | 3.04 | 2.18 | 2.49 |
| | chemical fungicide | | | | |
| Effectiveness | Pathogen control | 0.0 | 0.0 | 0.0 | 0.0 |
| | Pathogen + Aureobasidium | 3.2 | 3.1 | 2.4 | 5.4 |
| | Pathogen + chemical fungicide | 17.9 | 11.8 | 25.1 | 19.5 |
| | Pathogen + Aureobasidium + | 19.9 | 14.6 | 26.1 | 20.4 |
| | chemical fungicide | | | | |
| Expected value | Pathogen + Aureobasidium + | 20.5 | 14.5 | 26.9 | 23.9 |
| (E) | chemical fungicide | | | | |
| Synergism factor | | 1.0 | 1.0 | 1.0 | 0.9 |

| | | Aureobasidium strain | | | |
|---|---|---|---|---|---|
| | | DSM 14940 | DSM 14941 | AP 241 | AP 268 |
| | Chemical fungicide (w/v) | 0.1875 g/l cyprodinil 0.125 g/l fludioxonil | | | |
| Mean diameter | Pathogen control | 3.65 | 3.56 | 2.95 | 3.13 |
| of decay areas | Pathogen + Aureobasidium | 1.45 | 1.77 | 1.65 | 1.57 |
| (cm) | Pathogen + chemical fungicide | 1.73 | 1.93 | 1.64 | 1.82 |
| | Pathogen + Aureobasidium + | 1.54 | 1.38 | 1.26 | 1.25 |
| | chemical fungicide | | | | |
| Effectiveness | Pathogen control | 0.0 | 0.0 | 0.0 | 0.0 |
| | Pathogen + Aureobasidium | 60.3 | 50.3 | 44.1 | 49.8 |
| | Pathogen + chemical fungicide | 52.6 | 45.8 | 44.4 | 41.9 |
| | Pathogen + Aureobasidium + | 57.8 | 61.2 | 57.3 | 60.1 |
| | chemical fungicide | | | | |
| Expected value | Pathogen + Aureobasidium + | 81.2 | 73.0 | 68.9 | 70.8 |
| (E) | chemical fungicide | | | | |
| Synergism factor | | 0.7 | 0.8 | 0.8 | 0.8 |

It is clearly apparent from the above tables that the applications of the individual Aureobasidium pullulans strains together with the chemical fungicides fludioxonil or cyprodinil, and together with the mixture of fludioxonil and cyprodinil, do not have a synergistic effect.

| | | Aureobasidium strain | | |
|---|---|---|---|---|
| | | AP1: DSM 14940 + DSM 14941 | | |
| | | 0.1875 g/l cyprodinil | 0.125 g/l | 0.1875 g/l |
| | Chemical fungicide (w/v) | 0.125 g/l fludioxonil | fludioxonil | cyprodinil |
| Mean diameter | Pathogen control | 4.17 | 4.21 | 4.17 |
| of decay areas | Pathogen + Aureobasidium | 1.42 | 1.50 | 2.33 |
| (cm) | Pathogen + chemical fungicide | 1.83 | 1.17 | 3.63 |
| | Pathogen + Aureobasidium + | 0.33 | 0.08 | 1.83 |
| | chemical fungicide | | | |
| Effectiveness | Pathogen control | 0.0 | 0.0 | 0.0 |
| | Pathogen + Aureobasidium | 66.0 | 64.4 | 44.0 |
| | Pathogen + chemical fungicide | 56.0 | 72.3 | 13.0 |
| | Pathogen + Aureobasidium + | 92.0 | 98.0 | 56.0 |
| | chemical fungicide | | | |
| Expected value | Pathogen + Aureobasidium + | 85.0 | 90.1 | 51.3 |
| (E) | chemical fungicide | | | |
| Synergism factor | | 1.1 | 1.1 | 1.1 |

| | | Aureobasidium strain | | |
|---|---|---|---|---|
| | | AP 6: DSM 14940 + DSM 14941 | | |
| | | 0.1875 g/l cyprodinil | 0.125 g/l | 0.1875 g/l |
| | Chemical fungicide (w/v) | 0.125 g/l fludioxonil | fludioxonil | cyprodinil |
| Mean diameter | Pathogen control | 4.02 | 4.11 | 3.89 |
| of decay areas | Pathogen + Aureobasidium | 1.64 | 1.83 | 2.29 |
| (cm) | Pathogen + chemical fungicide | 1.74 | 1.62 | 3.51 |
| | Pathogen + Aureobasidium + | 0.41 | 0.05 | 1.67 |
| | chemical fungicide | | | |
| Effectiveness | Pathogen control | 0.0 | 0.0 | 0.0 |
| | Pathogen + Aureobasidium | 59.2 | 55.5 | 41.1 |
| | Pathogen + chemical fungicide | 56.7 | 60.6 | 9.8 |
| | Pathogen + Aureobasidium + | 89.8 | 98.8 | 57.1 |
| | chemical fungicide | | | |
| Expected value | Pathogen + Aureobasidium + | 82.3 | 82.4 | 46.9 |
| (E) | chemical fungicide | | | |
| Synergism factor | | 1.1 | 1.2 | 1.2 |

| | | Aureobasidium strain | | |
|---|---|---|---|---|
| | | AP 7: DSM 14940 + DSM 14941 | | |
| | | 0.1875 g/l cyprodinil | 0.125 g/l | 0.1875 g/l |
| | Chemical fungicide (w/v) | 0.125 g/l fludioxonil | fludioxonil | cyprodinil |
| Mean diameter | Pathogen control | 3.68 | 3.74 | 4.00 |
| of decay areas | Pathogen + Aureobasidium | 1.78 | 1.96 | 2.51 |
| (cm) | Pathogen + chemical fungicide | 1.83 | 2.04 | 3.38 |
| | Pathogen + Aureobasidium + | 0.32 | 0.54 | 1.78 |
| | chemical fungicide | | | |
| Effectiveness | Pathogen control | 0.0 | 0.0 | 0.0 |
| | Pathogen + Aureobasidium | 51.6 | 47.6 | 37.3 |
| | Pathogen + chemical fungicide | 50.3 | 45.5 | 15.5 |
| | Pathogen + Aureobasidium + | 91.3 | 85.6 | 55.5 |
| | chemical fungicide | | | |
| Expected value | Pathogen + Aureobasidium + | 75.9 | 71.4 | 47.0 |
| (E) | chemical fungicide | | | |
| Synergism factor | | 1.2 | 1.2 | 1.2 |

It is clearly apparent from the above table that the application of mixtures of the two Aureobasidium strains DSM 14940 and DSM 14941, together with the chemical fungicides cyprodinil or fludioxonil, and together with the mixture of cyprodinil and fludioxonil, has a significant synergistic effect. The effectiveness of the preparations of DSM 14940 and DSM 14941 together with the chemical fungicide(s) (test groups 4) in each case significantly exceeds the calculated expected value (E). The synergism factor is greater than or equal to 1.1.

Almost no decay (diameter of the decay area of 0.08 cm and 0.05 cm, respectively) developed in the AP 1 and AP 6 groups, each together with fludioxonil, which confirms the excellent prophylactic effect of the preparations according to the invention. In the remaining experiments for Groups AP 1, AP 6 and AP 7, a considerable reduction in the formation of decay was observed, which shows that the spread of the fungal disease is reduced by the preparations according to the invention.

| | | Aureobasidium strain | | | |
|---|---|---|---|---|---|
| | | AP 2: DSM | AP 3: DSM | AP 4: DSM | AP 5: DSM |
| | | 14940 + | 14940 + | 14941 + | 14941 + |
| | | AP 241 | AP 268 | AP 241 | AP 268 |
| | Chemical fungicide (w/v) | 0.125 g/l fludioxonil | | | |
| Mean diameter | Pathogen control | 3.13 | 3.18 | 2.99 | 2.98 |
| of decay areas | Pathogen + Aureobasidium | 2.97 | 2.83 | 2.73 | 2.70 |
| (cm) | Pathogen + chemical fungicide | 1.61 | 1.53 | 1.53 | 1.34 |
| | Pathogen + Aureobasidium + | 1.54 | 1.47 | 1.62 | 1.52 |
| | chemical fungicide | | | | |
| Effectiveness | Pathogen control | 0.0 | 0.0 | 0.0 | 0.0 |
| | Pathogen + Aureobasidium | 5.1 | 11.0 | 8.9 | 9.5 |
| | Pathogen + chemical fungicide | 48.5 | 51.8 | 48.9 | 55.1 |
| | Pathogen + Aureobasidium + | 50.7 | 53.7 | 45.8 | 49.1 |
| | chemical fungicide | | | | |
| Expected value | Pathogen + Aureobasidium + | 51.1 | 57.1 | 53.4 | 59.3 |
| (E) | chemical fungicide | | | | |
| Synergism factor | | 1.0 | 0.9 | 0.9 | 0.8 |

The synergistic effect of mixtures of AP 1, AP 6 and AP 7 with the two chemical fungicides cyprodinil and fludioxonil against the pathogen Botrytis cinerea Bc97 was also confirmed analogously to the above experiments with different concentrations of chemical fungicide.

The synergistic effect was able to be confirmed for cyprodinil for all concentrations, namely 0.02 g/l; 0.06 g/l; 0.125 g/l, 0.375 g/l; 0.5 g/l and 1.0 g/l preparation (synergism factor greater than or equal to 1.1), wherein the highest synergism factor was determined in each case for the concentrations 0.125 g/l and 0.375 g/l.

The synergistic effect was able to be confirmed for fludioxonil for all concentrations, namely 0.01 g/l; 0.05 g/l; 0.125 g/l, 0.25 g/L; 0.5 g/l and 1.0 g/l (synergism factor greater than or equal to 1.1), wherein the highest synergism factor was determined in each case for the concentrations 0.125 g/l and 0.25 g/l.
Botrytis cinerea 12/4
Test system: apples of the Jonagold Honsel cultivar
Storage temperature: 20° C.; storage period: 7 days
Pathogen: Botrytis cinerea 12/4 (no sensitivity or resistance to fludioxonil and/or cyprodinil)
Aureobasidium: DSM 14940, DSM 14941 and AP 1
Chemical fungicides: fludioxonil, cyprodinil; only 1/50 of the above-described amount of chemical fungicide was used.

| | | Aureobasidium strain | | |
|---|---|---|---|---|
| | | | | AP 1: DSM |
| | | DSM | DSM | 14940 + DSM |
| | | 14940 | 14941 | 14941 |
| | | 0.000375% cyprodinil (=0.00375 g/l preparation) | | |
| | Chemical fungicide (w/v) | 0.00025% fludioxonil (=0.0025 g/l preparation) | | |
| Mean diameter | Pathogen control | 3.60 | 3.57 | 3.63 |
| of decay areas | Pathogen + Aureobasidium | 1.88 | 2.22 | 1.64 |
| (cm) | Pathogen + chemical fungicide | 1.45 | 1.67 | 1.38 |
| | Pathogen + Aureobasidium + | 1.53 | 1.58 | 0.03 |
| | chemical fungicide | | | |
| Effectiveness | Pathogen control | 0.0 | 0.0 | 0.0 |
| | Pathogen + Aureobasidium | 47.8 | 37.8 | 54.8 |
| | Pathogen + chemical fungicide | 59.7 | 53.2 | 62.0 |
| | Pathogen + Aureobasidium + | 57.5 | 55.7 | 99.1 |
| | chemical fungicide | | | |
| Expected value | Pathogen + Aureobasidium + | 79.0 | 70.9 | 82.8 |
| (E) | chemical fungicide | | | |
| Synergism factor | | 0.7 | 0.8 | 1.2 |

It is clearly apparent from the above table that only the application of the mixture of the two Aureobasidium strains DSM 14940 and DSM 14941, together with the chemical fungicides cyprodinil and fludioxonil (AP 1 group), has a synergistic effect. The effectiveness of test group 4 (mixture of the Aureobasidium strains+chemical fungicide) considerably exceeds the calculated expected value (E). The synergism factor is greater than or equal to 1.1. Almost no decay (diameter of the decay area of 0.03 cm) developed, which confirms the excellent prophylactic effect of the preparation according to the invention.

The synergistic effect of mixtures of AP 1, AP 6 and AP 7 with the two chemical fungicides cyprodinil and fludioxonil against the pathogen Botrytis cinerea 12/4 was also confirmed analogously to the above experiments with different concentrations of chemical fungicide.

The synergistic effect was able to be confirmed for cyprodinil for all concentrations, namely 0.001 g/l; 0.00375 g/l; 0.005 g/l; 0.01 g/l; 0.05 g/l; 0.1 g/l and 0.1875 g/l (synergism factor greater than or equal to 1.1).

The synergistic effect was able to be confirmed for fludioxonil for all concentrations, namely 0.001 g/l; 0.0025 g/l; 0.005 g/l; 0.01 g/l; 0.05 g/l; 0.1 g/l and 0.125 g/l (synergism factor greater than or equal to 1.1).

Since the amounts of chemical fungicides used depends on the pathogen itself, but in particular on the resistance or reduced sensitivity thereof to the individual chemical fungicides, it is to be assumed that a higher or lower amount of the chemical fungicide is also sufficient for some pathogens to act synergistically with the Aureobasidium pullulans mixture of DSM 14940 and DSM 14941.

Neofabraea Spp:
Test system: apples of the Elstar Fuchshof cultivar
Storage temperature: 20° C.; storage period: 16 days
Pathogen: Pezicula malicorticis 160622 (DSM 62715)
Aureobasidium: DSM 14940, DSM 14941 and AP 1 (in contrast to what is stated above, the overall concentration of the Aureobasidium pullulans strains used here was 1×10⁷ cells/ml)
Chemical fungicides: fludioxonil, cyprodinil

| | | Aureobasidium strain | | |
|---|---|---|---|---|
| | | AP 1 (DSM 14940 + DSM 14941) | | |
| | | 0.1875 g/l cyprodinil | 0.125 g/l | 0.1875 g/l |
| | Chemical fungicide (w/v) | 0.125 g/l fludioxonil | fludioxonil | cyprodinil |
| Mean diameter | Pathogen control | 1.90 | 1.84 | 1.94 |
| of decay areas | Pathogen + Aureobasidium | 1.30 | 1.23 | 1.44 |
| (cm) | Pathogen + chemical fungicide | 0.94 | 1.91 | 1.61 |
| | Pathogen + Aureobasidium + | 0.33 | 1.09 | 0.83 |
| | chemical fungicide | | | |
| Effectiveness | Pathogen control | 0.0 | 0.0 | 0.0 |
| | Pathogen + Aureobasidium | 31.6 | 33.2 | 25.8 |
| | Pathogen + chemical fungicide | 50.5 | −3.8 | 17.0 |
| | Pathogen + Aureobasidium + | 82.6 | 40.8 | 57.2 |
| | chemical fungicide | | | |
| Expected value | Pathogen + Aureobasidium + | 66.8 | 30.6 | 38.4 |
| (E) | chemical fungicide | | | |
| Synergism factor | | 1.1 | 1.3 | 1.5 |

It is clearly apparent from the above table that the application of the two Aureobasidium strains DSM 14940 and DSM 14941, together with the chemical fungicides cyprodinil and fludioxonil, has a considerable a synergistic effect. The effectiveness of the pathogen+Aureobasidium+chemical fungicide (test group 4) in each case significantly exceeds the calculated expected value (E). The synergism factor is greater than or equal to 1.1.

Furthermore, the individual strains were also tested in a concentration of 1×10⁷ cells/ml in the test solution with the chemical fungicides cyprodinil (0.01875% (w/v)=0.1875 g cyprodinil per l of preparation) and fludioxonil (0.01250% (w/v)=0.125 g fludioxonil per l of preparation) individually and in combination (0.01875% (w/v) cyprodinil; 0.01250% (w/v) fludioxonil). The synergism factor was smaller than or equal to 1.0, and the use of the chemical fungicides with only one Aureobasidium pullulans strain is consequently not synergistic.

The synergistic effect of mixtures of AP 1, AP 6 and AP 7 with the two chemical fungicides cyprodinil and fludioxonil against the pathogen Pezicula malicorticis 160622 was also confirmed analogously to the above experiments with different concentrations of chemical fungicide.

The synergistic effect was able to be confirmed for cyprodinil for all concentrations, namely 0.02 g/l; 0.06 g/l; 0.125 g/l, 0.375 g/l; 0.5 g/l and 1.0 g/l preparation (synergism factor greater than or equal to 1.1), wherein the highest synergism factor was determined in each case for the concentrations 0.125 g/l and 0.375 g/l.

The synergistic effect was able to be confirmed for fludioxonil for all concentrations, namely 0.01 g/l; 0.05 g/l; 0.125 g/l, 0.25 g/l; 0.5 g/l and 1.0 g/l (synergism factor greater than or equal to 1.1), wherein the highest synergism factor was determined in each case for the concentrations 0.125 g/l and 0.25 g/l.

### EXAMPLE 2: FIELD TESTS

In outdoor trials (field tests), it was possible to show, for combating Botrytis spp., essentially Botrytis cinerea, in the case of wine (table grapes) and strawberries that the tank spray mix (preparation) of Aureobasidium pullulans DSM 14941 and DSM 14940, together with the chemical active substances cyprodinil and fludioxonil, was able to synergistically increase the effectiveness against the pathogen.

Test System A: Table Grapes (Vitis vinifera)
Location: Italy
Duration: Sep. 11 to Nov. 11, 2014

Number/type of application of the tank spray mixes: 5 identical treatments at 1,000 l/ha each. The tank mixes were applied by way of spraying. The spray application was carried out in each case in keeping with the BBCH scale of the phenological development stages of the grapevine (Lorenz et al., Phänologische Entwicklungsstadien der Weinrebe. Vitic. Enol. Sci. 49, 66-70, 1994) in the following development stages:
BBCH 53: “Flower clusters” (inflorescences) clearly visible
Test system B: Strawberries (Fragaria ananassa)
Location: Austria
Duration: May 9 to Jun. 10, 2016

Number/type of application of the tank mixes: 6 identical treatments at 1,000 l/ha each. The tank mixes were applied by way of spraying.

The spray application was carried out in each case in keeping with the BBCH scale of the phenological development stages of the strawberry (Meier et al., Phänologische Entwicklungsstadien des Kernobstes, des Steinobstes, der Johannisbeere and der Erdbeere. Nachrichtenbl. Deut. Pflanzenschutz., 46, 141-153, 1994) in the following development stages:

BBCH 55: First set flowers at the bottom of the rosette

In the respective test groups, the following spray mixtures were applied directly to the field fruits:

Group 1: untreated control

Group 2: treated with cyprodinil and fludioxonil; concentration in the tank mix: 0.1875 g/l cyprodinil and 0.125 g/l fludioxonil. As a result, 187.5 g cyprodinil and 125 g fludioxonil was applied per hectare (ha) to the plant cultures.

Group 3: treated with AP 1; Aureobasidium pullulans concentration in the tank mix: 2.5×10⁶ cells/ml DSM 14940 and 2.5×10⁶ cells/ml DSM 14941. As a result, 2.5×10¹² cells DSM 14940 and 2.5×10¹² cells DSM 14941 were applied per hectare (ha).

Group 4: treated with cyprodinil and fludioxonil as well as with AP 1; concentrations in the tank mix (=preparation): 0.1875 g/l cyprodinil and 0.125 g/l fludioxonil as well as 2.5×10⁶ cells/ml DSM 14940 and 2.5×10⁶ cells/ml DSM 14941. As a result, 187.5 g cyprodinil and 125 g fludioxonil was applied to the plant cultures, as well as 2.5×10¹² cells DSM 14940 and 2.5×10¹² cells DSM 14941.

| Synergy of AP 1 + mixture of | | | |
|---|---|---|---|
| cyprodinil and fludioxonil | Field fruit | Table grape | Strawberry |
| Proportion of fruits infected | Group 1 | 27.30 | 62.30 |
| with the pathogen [%] | Group 2 | 9.80 | 27.60 |
| | Group 3 | 15.10 | 45.80 |
| | Group 4 | 2.30 | 10.10 |
| Effectiveness | Group 1 | 0.0 | 0.0 |
| | Group 2 | 64.1 | 55.7 |
| | Group 3 | 44.7 | 26.5 |
| | Group 4 | 91.6 | 83.8 |
| Expected value (E) | Group 4 | 80.1 | 67.4 |
| Synergism factor | | 1.1 | 1.2 |

Calculation of the effectiveness: for example for Group 4: effectiveness=[1−(2.30/27.30)]*100

The above table clearly shows the synergistic reduction in the spread of the pathogen as a result of the joint application of the AP 1 mixture with the chemical fungicides. The synergism factor in each case is greater than or equal to 1.1.

Analogously to the above table, the following groups were also tested as further groups in the field tests (table grape and strawberry):

Group 5: treated with cyprodinil; concentration of cyprodinil in the tank mix: 0.1875 g/l; application: 1,000 l/h

Group 6: treated with fludioxonil; concentration of fludioxonil in the tank mix: 0.125 g/l; application: 1,000 l/h

Group 7: treated with cyprodinil as well as with AP 1; concentrations in the tank mix: 0.1875 g/l cyprodinil as well as 2.5×10⁶ cells/ml DSM 14940 and 2.5×10⁶ cells/ml DSM 14941; application: 1,000 l/h

Group 8: treated with fludioxonil as well as with AP 1; concentrations in the tank mix: 0.125 g/l fludioxonil as well as 2.5×10⁶ cells/ml DSM 14940 and 2.5×10⁶ cells/ml DSM 14941; application: 1,000 l/h

During the analogous evaluation of Groups 1, 3 and 5 to 8, a synergistic effect was also established, that is, a synergism factor of greater than or equal to 1.1 was achieved, for the application of the AP 1 mixture, together with only one of the two chemical fungicides, each compared to the individual use (chemical fungicide or AP 1 mixture).

The synergistic effect of mixtures of AP 1 with the two chemical fungicides cyprodinil and fludioxonil against pathogens was also confirmed analogously to the above field tests with different concentrations of chemical fungicide.

The synergistic effect was able to be confirmed for cyprodinil for all application amounts, namely 20 g/ha; 100 g/ha; 187.5 g/ha; 375 g/ha, 500 g/ha and 1000 g/ha (synergism factor greater than or equal to 1.1), wherein the highest synergism factor was determined in each case for the application of 187.5 g/ha and 375 g/ha.

The synergistic effect was able to be confirmed for fludioxonil for all application amounts, namely 10 g/ha; 50 g/ha; 125 g/ha; 250 g/ha; 500 g/ha and 1000 g/ha (synergism factor greater than or equal to 1.1), wherein the highest synergism factor was determined in each case for the application of 125 g/ha and 250 g/ha.

1. A preparation comprising at least one chemical fungicide, characterized in that, in addition to the at least one chemical fungicide, a mixture comprising at least the Aureobasidium pullulans strains DSM 14940 and DSM 14941 is present, the at least one chemical fungicide and the mixture of the Aureobasidium pullulans strains being present in the preparation in synergistically effective amounts, and that the at least one chemical fungicide is selected from fludioxonil or a combination comprising fludioxonil and cyprodinil.

2. The preparation according to claim 1, wherein the Aureobasidium pullulans strains DSM 14940 and DSM 14941 are present in the preparation in a cell quantity ratio of 2:1 to 1:2.

3. The preparation according to claim 1, wherein the Aureobasidium pullulans strains DSM 14940 and DSM 14941 are each present in a concentration of 1×10⁵ to 1×10⁸ cells/ml preparation as synergistically effective amounts.

4. The preparation according to claim 1, wherein cyprodinil is present in a concentration of 0.00375 g/l preparation to 5 g/l preparation as a synergistically effective amount.

5. The preparation according to claim 1, wherein fludioxonil is present in a concentration of 0.0025 g/l preparation to 5 g/l preparation as a synergistically effective amount.

6. The preparation according to claim 1, wherein cyprodinil and fludioxonil are present in the preparation in a weight ratio of 2:1 to 1:2.

7. The preparation according to claim 1, wherein Aureobasidium pullulans DSM 14940 and DSM 14941 are each present in a cell quantity ratio of 1×10⁶ to 2×10⁷ cells/ml preparation, and the chemical fungicides fludioxonil and cyprodinil are present in a concentration of 0.0025 g/l preparation to 1.0 g/l preparation in the case of fludioxonil, and 0.00375 g/l preparation to 1.0 g/l preparation in the case of cyprodinil.

8. Use of a preparation according to claim 1, wherein for the prophylaxis or for the reduction of the spread of plant diseases caused by fungal pathogens.

9. The use according to claim 8, wherein the fungal pathogens are selected from the group consisting of Neofabreaea spp. and Botrytis spp.

10. The use according to claim 8, wherein the fungal pathogens exhibit resistance and/or reduced sensitivity to at least one chemical fungicide.

11. A method for the prophylaxis or the reduction of the spread of at least one plant disease caused by a fungal pathogen, characterized by applying
a) at least one chemical fungicide selected from fludioxonil or a combination comprising fludioxonil and cyprodinil and
b) a mixture comprising at least the Aureobasidium pullulans strains DSM 14940 and DSM 14941
jointly at least once to a crop plant, wherein a) and b) are applied in synergistically effective amounts to the crop plant.

12. The method according to claim 11, characterized in that a) and b) are mixed, dissolved or suspended jointly in a preparation, and that the preparation is applied to the crop plant.

13. (canceled)

14. The method according to claim 11, wherein 1×10¹¹ to 1×10¹⁴ cells/ha preparation of the Aureobasidium pullulans strains DSM 14940 and DSM 14941 are applied per application as synergistically effective amounts.

15. The method according to claim 11, wherein fludioxonil is used as the at least one chemical fungicide, 2.5 g/ha to 5000 g/ha being applied as a synergistically effective amount.

16. The method according to claim 11, wherein cyprodinil is used as the second chemical fungicide, 3.75 g/ha to 5000 g/ha being applied as a synergistically effective amount.

17. The method according to claim 11, wherein the at least one application of the at least one chemical fungicide and the mixture comprising at least the Aureobasidium pullulans strains DSM 14940 and DSM 14941 is carried out during the flowering stage of the crop plant.
